(19) United States
(12) Patent Application Publication
(10) Pub. No.: US 2014/0318010 A1
(43) Pub. Date: Oct. 30, 2014

(54) Modular Tensile Vegetated Wall System

(71) Applicant: David J. Tomlinson, Friday Harbor, WA (US)

(72) Inventor: David J. Tomlinson, Friday Harbor, WA (US)

(21) Appl. No.: 13/869,994

(22) Filed: Apr. 25, 2013

(51) Int. Cl. A01G 9/02

(52) U.S. Cl. CPC A01G 9/025
USPC 47/65.8

(57) ABSTRACT

Embodiments include but are not limited to modular tensile vegetated wall systems. A module may be comprised of a modular structural frame consisting of not less than two parallel vertically oriented structural members supporting at least one transverse support, wherein a first continuous fabric is folded horizontally over the modular structural frame such that the volume of the folds may be sufficient to contain both plant material and growing medium on the ventral side, and wherein the first continuous fabric has at least one opening to receive planting material, and wherein a second continuous fabric is folded horizontally over the modular structural frame on the dorsal side and partially folded into the cavity or cavities produced by the fold or folds of the first fabric. The vegetated wall system includes integrated irrigation. Other embodiments may be described and/or claimed.

### RELATED US APPLICATION DATA

The present application claims priority to U.S. Provisional Patent Application No. 61/638,453, filed Apr. 25, 2012, the entire specification of which is hereby incorporated by reference in its entirety for all purposes.

### PUBLICATION CLASSIFICATION

47/65.8;

### TECHNICAL FIELD

The invention relates to a system for growing plants. More specifically, the invention relates to a system for growing plants along or adjacent to a vertical or inclined wall. Embodiments of the present invention relate generally to a vegetated wall system and more particularly to a modular tensile vegetated wall system.

### BACKGROUND OF THE INVENTION

Vegetated wall systems of various types are becoming more widely known. Such systems are typically deployed to provide one or more ecosystem services in urban areas, such as: (i) habitat provision; (ii) ambient green space; (iii) noise attenuation; (iv) thermal regulation; and (v) air filtration, which may benefit the urban environment. These systems apply a vegetated covering to building facades, and contribute to what may be referred to generally as façade greening. Three basic variations of vegetated wall systems exist: green facades, green walls, and vertical gardens. Green facades employ climbing plants, rooted in the ground below the facade, to cover and shade the façade; or in the case of retaining walls, provide for a cavity behind the facade in which the plant may grow. Green walls and vertical gardens permit plants to be grown in front of the façade, and offer retrofit options for existing buildings. Green walls employ a modular system that retains the growing medium and plant material. These modules are typically made of a rigid material like HDPE or other similar plastics, where the module is further divided into cells, and is fastened to a rigid frame or, in some cases, to the façade directly. Green walls are the most numerous in variety. Vertical gardens are primarily soilless systems, where the plants are supported by a synthetic woven fabric, and may incorporate a root cloth which allows for the continuous growth of the roots along such a fabric. Each vegetated wall system provides for irrigation by different means, as nutrient supply is critical to the viability of the plant specimens. The term “living wall” is often employed in the description of these systems, though its exact significance remains vague.

Each vegetated wall system provides for the support of plant root structure, containment of growing medium, and delivery of irrigation water. However, each system has its own draw back. In the case of green facades, plants may die-back in the winter season, and are restricted by both climbing height and rate, depending upon the species selected. Façade coverage is also more challenging to predict and control. Green wall systems often uniform coverage but often constrict root growth due to their cellular construction. The materiality of their cellular construction can also contribute to over-heating of plant material, resulting in either plant stress or death. Green walls also employ a large amount of material to support the vegetation, increasing their carbon footprint and embodied energy. While vertical gardens permit extensive root growth potential, they typically incorporate species that are non-native to the sites in which they are installed, as installed plant species are typically selected based on certain advantageous adaptations such as the ability to thrive on rock faces or on trees high above the ground, and sometimes in naturally soilless conditions. While well adapted to a harsh growing environment such as a building façade, non-native species do not necessarily provide ecological functions such as habitat provision. Likewise, green walls and vertical gardens deprive the plants of their main strategy for stress management: a microbial-rich soil environment. Green walls contribute to this deprivation by employing synthetic or mineral-based growth medium, very low in organic components and vertical gardens remove the soil component entirely. This requires costly irrigation systems that must supply all the prerequisite nutrients to the plant, as they are unable to synthesize many of these nutrients in natural fashion, or in combination with microbial processes. This in turn results in an extremely delicate, un-resilient system.

Numerous examples of prior art relate in part to the present invention, and are discussed here.

Patent US 2009/0223126 A1 (Sep. 10, 2009) and U.S. Pat. No. 7,926,224 B1 (Apr. 19, 2011) both describe an orthogonally cellular modular device for vertical plant support corresponding to the aforementioned green wall category of vegetated wall systems.

US Patent Application 2013/0067809 A1 (Mar. 21, 2013) and US Patent Application 20080110086 A1 (May 15, 2008) both describe formally planar configurations that utilize textiles to grow plants vertically, corresponding to the aforementioned vertical garden or living wall category of vegetated wall systems.

U.S. Pat. No. 4,960,349 (Oct. 2, 1990) describes materials and techniques for retaining earth in which a geo-grid is applied in layers with accompanying backfill to retain an embankment. U.S. Pat. No. 8,246,274 B1 (Aug. 21, 2012) elaborates on an installation method for such reinforcement. In both, individual mesh panels are embedded in the earth in built-up layers consisting of geo-grid and stratified soils in an effort to improve the stability of an embankment or slope. Structural continuity is generated through contact with stratified soils through separate, vertically discontinuous geo-grid panels. Likewise, EP0385067 A2 (Sep. 5, 1990) demonstrates an improved method of reinforcing retained soils which involves folding horizontally oriented but vertically discontinuous geo-fabric panels back into the soil strata, and EP0480890 A1 (Apr. 15, 1992) proposes to install plants at each layer of geo-grid-reinforced soil strata. These techniques correspond to the aforementioned green façade category of vegetated wall systems.

US Patent Application 20120317922 A1 (Dec. 20, 2012) describes a planted wall in which a geo-fabric is formed into a bag which is closed at each end, fixed with apertures for plantings, and secured by means of a matrix of poles. The first bag rests on grade and each successive bag unit is stacked upon the first.

U.S. Pat. No. 5,579,603 A (Dec. 6, 1996), describes a plant-growing method for greening walls in which singular, horizontally oriented cellular bags are suspended. Each bag is constructed as a singular, horizontal assembly, separated in structure and construction from any adjacent bag. The publication does not elaborate on how more than one bag may be suspended from a façade at the same time, how a bag may be supported or how one bag may be coupled to another, either structurally or voluminously.

U.S. Pat. No. 8,141,294 B2 (Mar. 27, 2012) describes a planter system for supporting living plants on a vertical surface by means of vertically-arranged knife pleated, vertically-oriented pockets. These pockets host removable pouches that contain the plantings and growth medium, permitting plants to be transplanted and replaced. Such pockets constrain the growth of roots by volumetrically limiting the amount of growth medium, or force the roots to grow into the fabric, resulting in an effective hydroponic condition, thereby necessitating multiple strategies for irrigation and nutrient delivery.

US Patent Application 20060131107 A1 (Feb. 28, 2005) describes rigging for a suspended scaffold assembly that is comprised of widely known components.

The present invention proposes a novel planter system and methods and techniques as well as provides a resolution to the issues addressed above.

### SUMMARY OF THE INVENTION

The invention addresses the previously discussed shortcomings of other vegetated wall systems by utilizing a tensile-based structural system which is lighter in comparison to many cellular constructions that rely on compressive structural members. By horizontally folding a continuous fabric over a modular structural frame, capacity for plant growing medium can be increased over other constructions that employ fabrics in a formally planar configuration. Additionally, through the horizontal configuration, individual folds may be formed such that they are tangent to an adjacent fold, providing for increased root growth from one fold to the next while allowing for a volume of growing medium.

Embodiments of the invention include a planter system and methods and techniques for supporting living plants along or adjacent to a vertical surface. Such surfaces may be comprised of, but not limited to, a building façade or similarly erected structure.

Embodiments of the invention include a planter system and methods and techniques for supporting plants from an overhead structure. Such overhead structures may be comprised of, but not limited to, overpasses or bridges, or similarly erected structures, or that portion of a building corresponding to the parapet.

Embodiments of the invention include a planter system and methods and techniques in which a fabric is formed into one or more horizontally-oriented folds. The folds are formed such that the volume of the fold or folds may be sufficient to contain both plant material and growing medium. The folded fabric may be slit to accommodate plant material. The folded fabric is supported at each fold by a transversal structural member sufficient to support the weight of the fold or folds, and the contained plant material and growing medium. The transversal structural member is structurally coupled to a pair of parallel vertically oriented structural members, set a distance apart from one another, the distance corresponding to the width of the module. The fabric may be fabricated from any material suitable to the application, and may include multiple types of fabrics as appropriate to the orientation and function of each fabric. Fabrics are selected based upon their strength, perviousness, imperviousness, biodegradability, hydrophilic or hydrophobic characteristics, recycled content, flammability, ultra-violet resistance and durability. Fabrics may be off-the-shelf products or custom fabricated.

Embodiments of the invention include material drawn from the group consisting of polymers/tangle material, synthetic fibers, adhered synthetic fibers, natural fibers, glass, ceramic, plastic, metal, or stone. In some embodiments the open ends of the folds are closed by a panel, which is secured to the fabric. In some embodiments the ends of the folds are closed by folding the fabric ends inward and securing it.

Embodiments of the invention include a modular structural frame to support the folded fabric. Such a frame may be fabricated from any material suitable in performance and characteristics for support of the folded fabric, including but not limited to: aluminum, steel, or any alloy thereof; fiberglass; carbon fiber; or other appropriate material.

Embodiments of the invention include the repetition of the module consisting of the modular structural frame and supported fabric across the façade of any suitable building. Embodiments of the invention include the ability to raise and lower the assembled planter system modules such that maintenance may be performed at a desired height, preferably ground level.

Embodiments of the invention include the manipulation of the geometry of both the folds and the modular structural frames supporting the fabric, such that the size, shape, curvature, radius, and dimensions may be altered to produce numerous effects and benefits.

Embodiments of the invention include rigging and other connections that enable the raising and lowering of planter system modules. Embodiments of the invention include the use of normal rigging and hoisting hardware such as winches, pulleys, turnbuckles, shackles, hitches, thimbles and swages.

Embodiments of the invention include replaceable modules such that one module may be removed to allow for the insertion of another.

Embodiments of the invention include a plant growing medium comprised of organic material, inorganic material, and combination of both in proportion to the desired mix. The plant growing medium may be amended with any number of substances such as biochar, or inoculated with beneficial mycorrhizae.

Embodiments of the invention include the installation of an irrigation system or systems for water and nutrient delivery, installed both internal to the module and external to it, or in combination.

### BRIEF DESCRIPTION OF THE DRAWINGS

Embodiments of the present invention will be readily understood by the following descriptions of the drawings, referenced in the disclosure below. Embodiments of the invention are illustrated by way of example and not by way of limitation in the figures of the accompanying drawings.

FIG. 1 illustrates a schematic vertical section of the invention, showing a single module which consists of structural support members and continuous fabrics folded horizontally over the support frame, in accordance with various embodiments of the present invention.

FIG. 2 illustrates an enlargement of FIG. 1, and illustrates a schematic vertical section of the invention consistent with FIG. 1, showing a portion of a single module which consists of structural support members and continuous fabrics folded over the support frame, in accordance with various embodiments of the present invention. It can be seen that the outer-most fabric may be amended with additional fabrics on the interior to perform various desired functions such as moisture retention or further retention of the growing medium.

FIG. 3-FIG. 6 illustrate an embodiment of the invention consisting of two modules in which the parallel, vertically oriented structural members are radiused and fitted to a guide track, where the direction of curvature of the parallel vertically oriented structural members is reversed between the two modules, and the continuous fabric is discontinuous between modules, in accordance with various embodiments of the present invention.

FIG. 7-FIG. 11 illustrate an embodiment of the invention in which the module is composed of a lesser number of continuous folds, in accordance with various embodiments of the present invention.

FIG. 12 illustrates an embodiment of the invention in which a steel net assembly is fitted external to the continuous horizontally folded fabric as a means of additional support, in accordance with various embodiments of the present invention. The first fold is omitted for clarity.

FIG. 13 illustrates multiple schematic embodiments of the invention in which the continuous folds are modified geometrically, as may be needed to accommodate varying factors including but not exclusive of weight or root capacity, and in accordance with various embodiments of the present invention.

FIG. 14 illustrates an embodiment of the invention in which the support frame is composed of cables, held apart by transverse spreaders, in accordance with various embodiments of the present invention.

### DETAILED DESCRIPTION OF EMBODIMENTS OF THE INVENTION

A modular tensile vegetated wall system as provided by the embodiments represented in the accompanying drawings which form a part hereof and are referenced below.

In many embodiments, the invention is bi-laterally symmetrical about a vertical axis, and a feature on one side or along one edge is generally replicated on the opposite side. This is evident in the drawings and a call out for one item on one side presumes the presence of the item on the opposite side where the drawing depicts a bi-laterally symmetrical condition. Elements in an illustration of an embodiment may be omitted for clarity from another illustration of the same or different embodiment. It will become clear to one skilled in the art that the invention is not limited to a single preferred embodiment, but that different configurations of the elements described herein and based on the understanding of the invention will enable one to address various external parameters within the system of the invention presented here with minimal modifications as discussed herein and in accordance with various embodiments of the present invention.

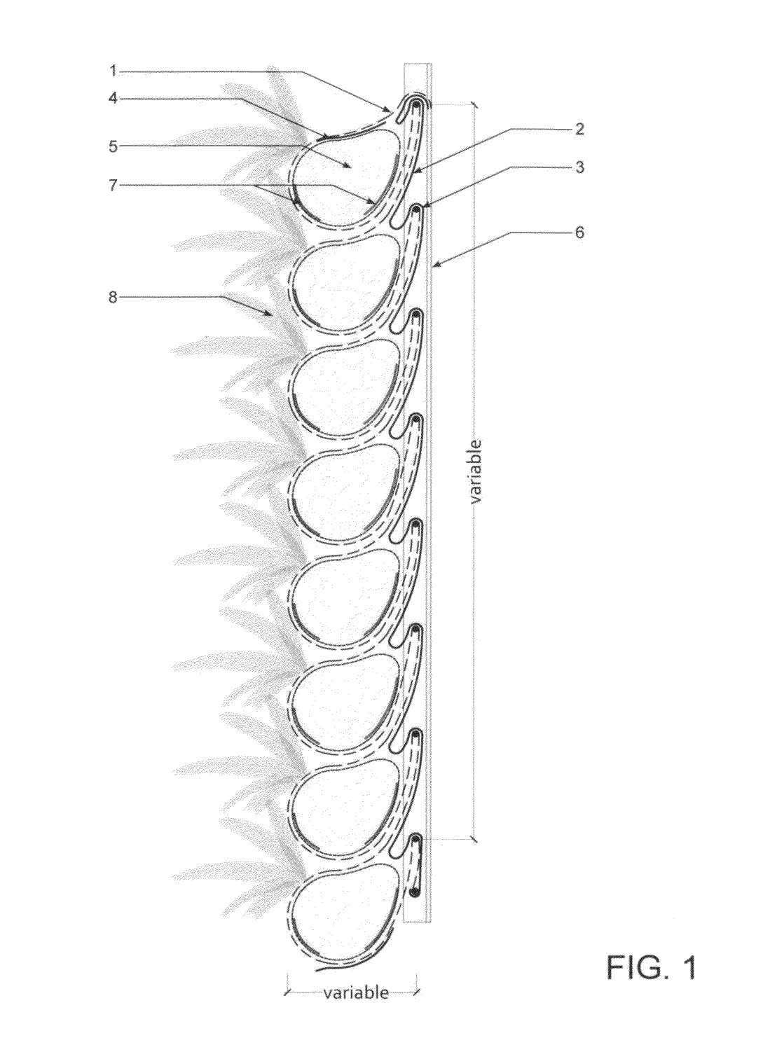

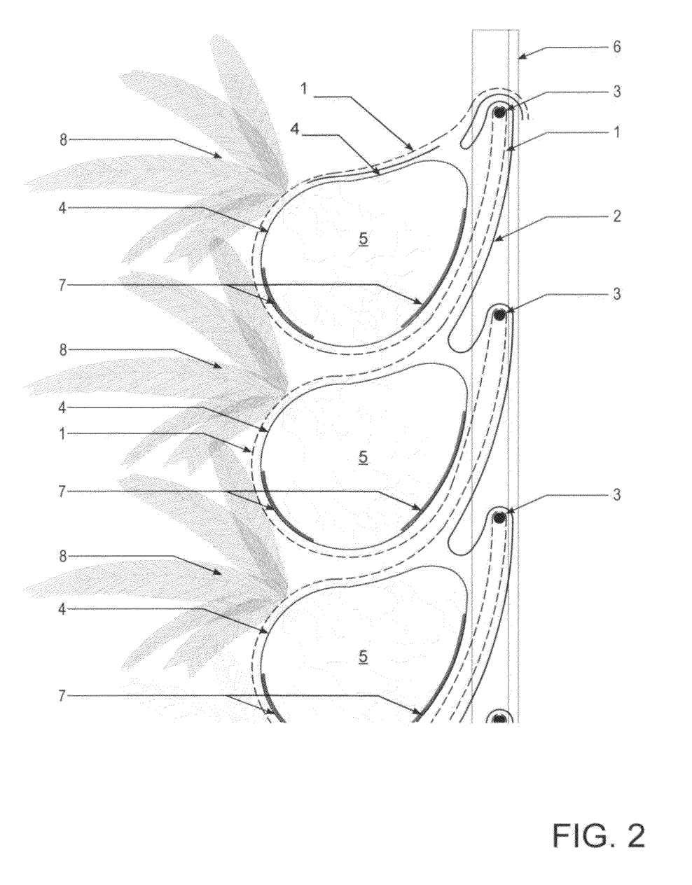

FIG. 1-2 illustrate a schematic vertical section of the invention, showing a single module which consists of structural support members and a continuous fabric folded horizontally over the support frame, in accordance with various embodiments of the present invention. The embodiment is characterized by a continuous fabric 1, which may be comprised of polymers/tangle material, synthetic fibers, adhered synthetic fibers, natural fibers, glass, ceramic, plastic, metal, or stone, and uniformly folded horizontally over a set of transverse supports 3, which are structurally coupled to and span between two parallel vertically-oriented structural members 6. The continuous fabric 1 is formed such that the volume of the fold or folds may be sufficient to contain both plant material 8 and growing medium 5 on the ventral side of the module. The folding may be uniform or non-uniform, depending upon the requirements of the selected species of plant material 8, and the configuration of the transverse supports 3. The continuous fabric 1 need only be secured to the first transverse support and the last. Such fastening may be carried out by any means which provides a secure and preferably adjustable fit. A second fabric 2 is likewise folded over the transverse supports 3 and partially folded into the dorsal folds of 1, and where the second fabric is impermeable it may serve as a moisture barrier. In various embodiments, additional fabrics may be arranged to augment certain functions within the cavity of the horizontally folded continuous fabric 1. A hydrophilic fabric 7 is laid into each fold and is fastened or held in place by the growing medium 5 to aid in the retention of moisture, and a growing medium wrap 4, which may be comprised of organic components in certain embodiments, and aids in the further retention of the growth medium until sufficient root growth is established by the plant material 8. The weight of the growing medium 5 should be allowed to induce a sag in the folded continuous fabric 1 such that the bottom surface of the upper fold is continuous with the top surface of the lower fold over a certain distance related to the size of the folding in order to permit root growth between fold cavities.

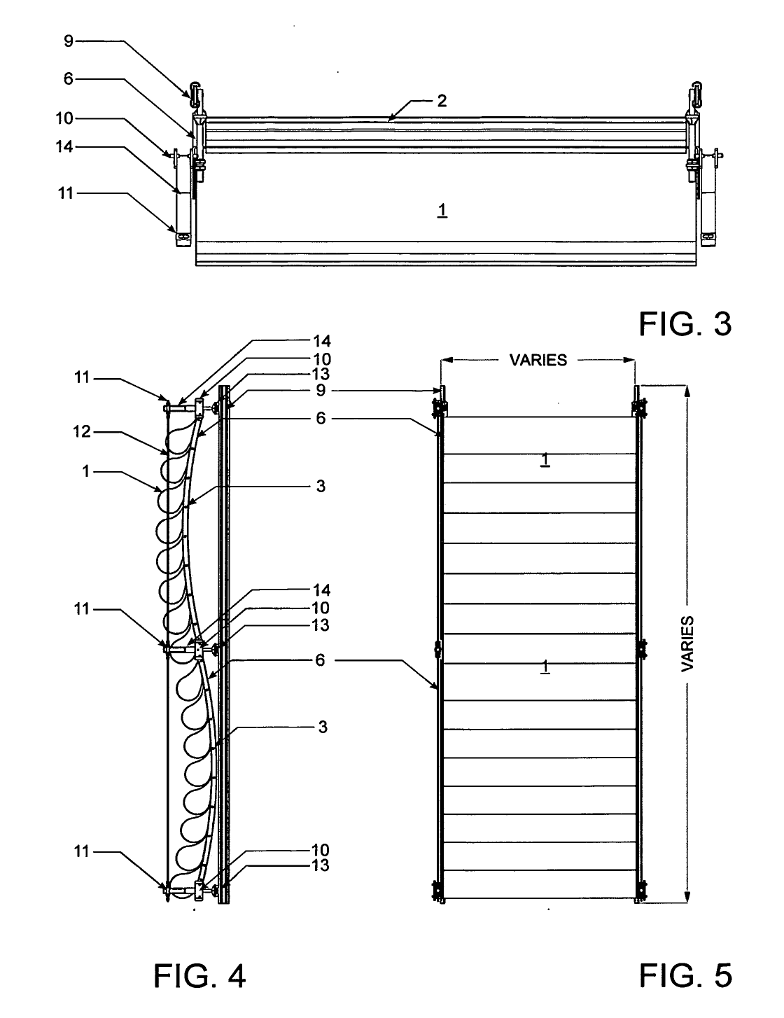

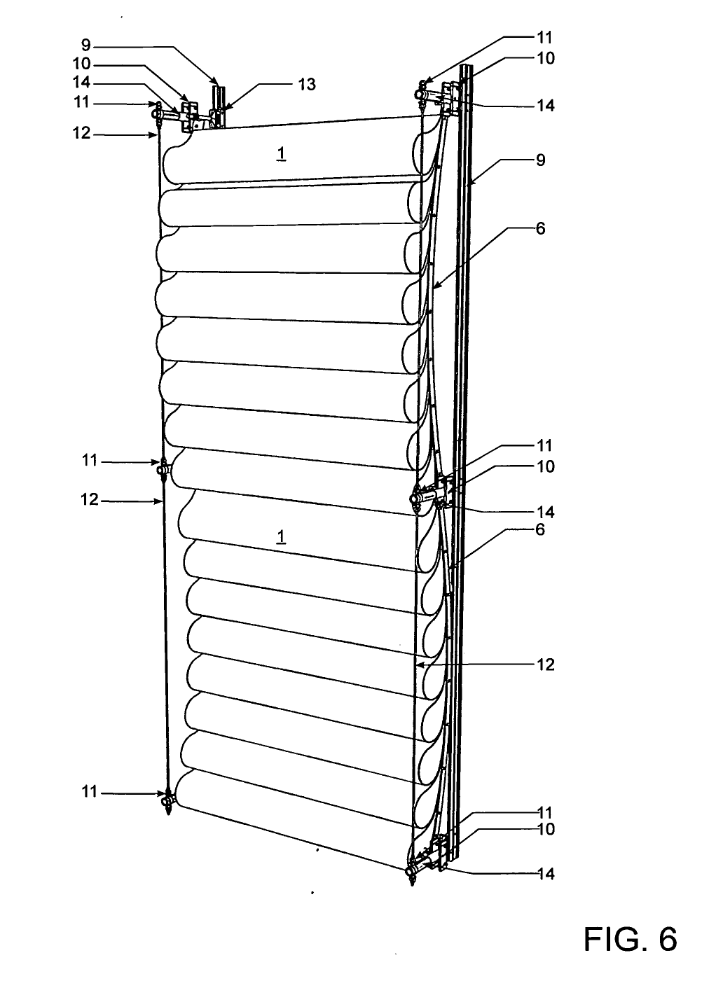

FIG. 3-FIG. 6 illustrate an embodiment of the invention consisting of two modules in which the parallel, vertically oriented structural members are radiused and fitted to a guide track, where the direction of curvature of parallel, vertically oriented structural members is reversed between the two modules, and the continuous fabric is discontinuous between modules, in accordance with various embodiments of the present invention. The embodiment is characterized by a continuous fabric 1, which may be comprised of polymers/tangle material, synthetic fibers, adhered synthetic fibers, natural fibers, glass, ceramic, plastic, metal, or stone, and folded horizontally over a set of transverse supports 3, which are structurally coupled to and span between two parallel vertically-oriented structural members 6. The continuous fabric 1 is formed such that the volume of the fold or folds may be sufficient to contain both plant material and growing medium on the ventral side of the module. The folding may be uniform or non-uniform, depending upon the requirements of the selected species of plant material 8, and the configuration of the transverse supports 3. In the given embodiment, the parallel vertically-oriented structural members 6 are radiused. The structural modular frame 3 & 6 is supported by a tensile element 12 and an outrigger arm 14, the outboard end of which is structurally coupled to the tensile element 12 at anchor attachment 11. The outrigger arm 14 allows for support at the center of gravity of the outwardly radiused parallel vertically-oriented structural members 6, and as such its length is dependent upon the calculated centroid of the structural modular frame 3 & 6 when weighted by the addition of growing medium contained within 1. The inboard portion of the outrigger arm 14 is coupled to the radiused, parallel vertically-oriented structural members 6 at fastener plate assembly 10. The fastener plate assembly 10 is coupled to a guide assembly 13 which is fitted to a guide track 9. The fastener plate assembly 10 also functions as a structural coupling between adjacent modules. The guide track may be fastened to the building façade or other vertical surface. In the given embodiment, the guide assembly is constructed of an exterior-grade wheel on an axle, coupled to the outrigger arm 14, and fitted to the guide track 9. The tensile element 12 may be fastened to the anchor attachment 11 using well known rigging hardware such as turnbuckles, hitches, shackles, thimbles and/or swages, and may be coupled to a pulley system for raising and lowering of the present invention to permit ground-based maintenance access.

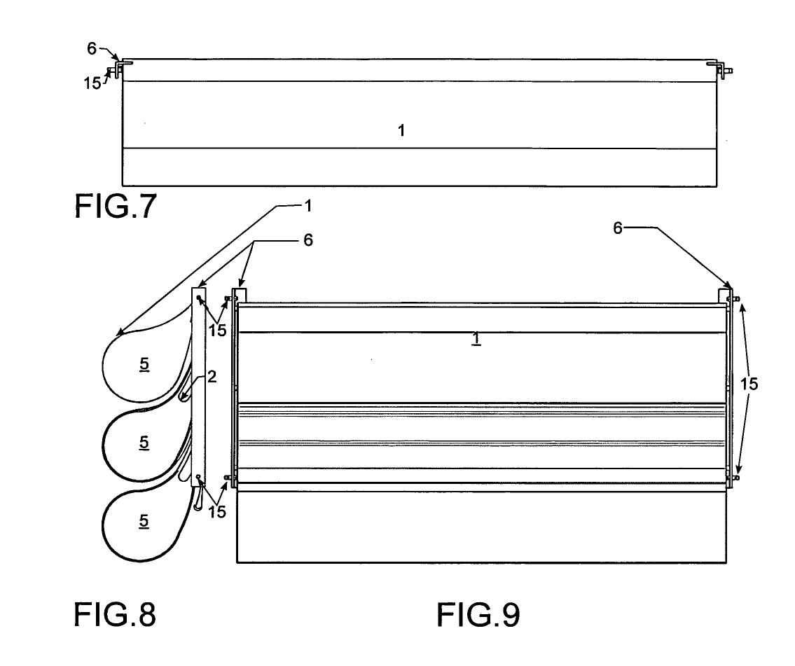

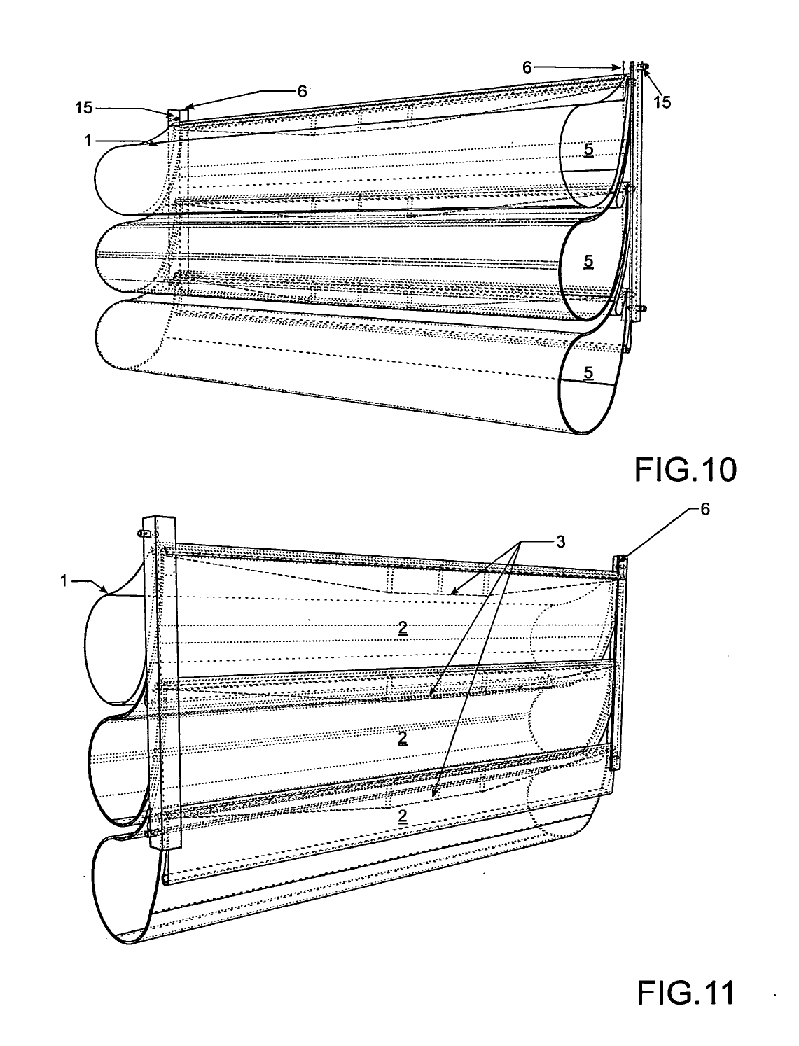

FIG. 7-FIG. 11 illustrate an embodiment of the invention in which the module is composed of a lesser number of continuous folds, in accordance with various embodiments of the present invention. The embodiment is characterized by a continuous fabric 1, which may be comprised of polymers/tangle material, synthetic fibers, adhered synthetic fibers, natural fibers, glass, ceramic, plastic, metal, or stone, and folded horizontally over a set of transverse supports 3, which are structurally coupled to and span between two parallel vertically-oriented structural members 6. The continuous fabric 1 is formed such that the volume of the fold or folds may be sufficient to contain both plant material and growing medium on the ventral side of the module. The folding may be uniform or non-uniform, depending upon the requirements of the selected species of plant material, and the configuration of the transverse supports 3. A second fabric 2 is likewise folded over the transverse supports 3 and partially folded into the dorsal folds of 1, and where the second fabric is impermeable it may serve as a moisture barrier. The weight of the growing medium 5 should be allowed to induce a sag in the folded continuous fabric 1 such that the bottom surface of the upper fold is continuous with the top surface of the lower fold over a certain distance related to the size of the folding in order to permit root growth between fold cavities. The structural modular frame 3 & 6 may be secured into a façade-anchored support by way of hanger pin 15. In FIG. 11, transverse supports 3 are shown as cable truss construction.

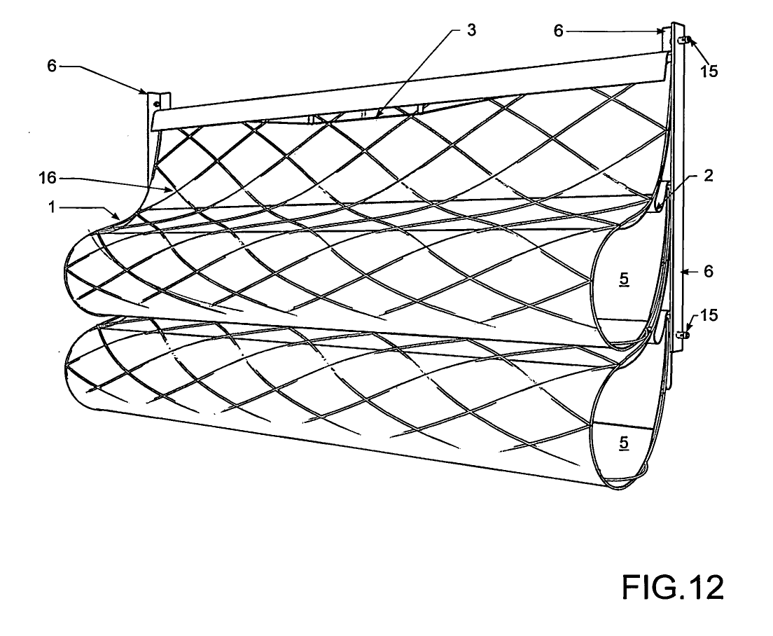

FIG. 12 illustrates an embodiment of the invention in which a steel net assembly is fitted external to the continuous folds as a means of additional support, in accordance with various embodiments of the present invention. The upper-most fold is omitted for clarity. The embodiment is characterized by a continuous steel net assembly 16 sufficient in strength to support both plant material and growing medium, folded horizontally over transverse supports 3, which are structurally coupled to and span between two parallel vertically-oriented structural members 6. The continuous fabric 1 is formed such that the volume of the fold or folds may be sufficient to contain both plant material and growing medium. The folding may be uniform or non-uniform, depending upon the requirements of the selected species of plant material and the configuration of the transverse supports 3. Hanger pin 15, fixed to each parallel vertically-oriented structural member 6, allows for securing the modular assembly to a secondary structure such as a suspended tension cable or façade stand-off frame, where each may be ultimately supported by a primary structure according to convention.

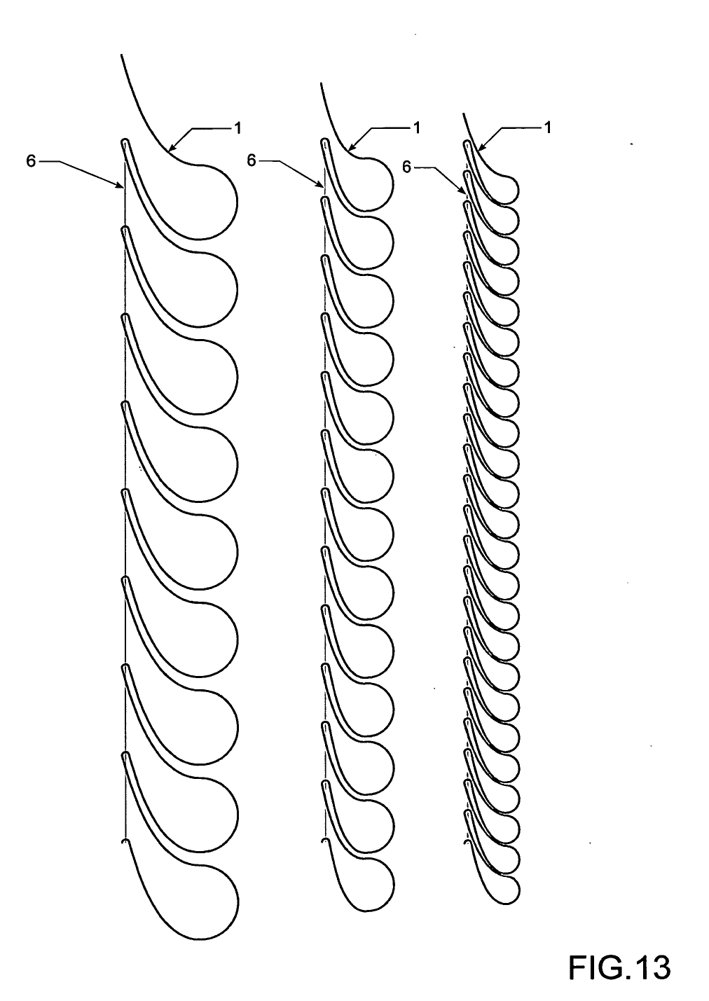

FIG. 13 illustrates multiple schematic embodiments of the invention in which the continuous folds are modified geometrically, as may be needed to accommodate varying factors including but not exclusive of weight or root capacity, and in accordance with various embodiments of the present invention. The embodiment is characterized by a continuous fabric 1, which may be comprised of polymers/tangle material, synthetic fibers, adhered synthetic fibers, natural fibers, glass, ceramic, plastic, metal, or stone, and folded horizontally over a set of transverse supports which are structurally coupled to and span between two parallel vertically-oriented structural members 6.

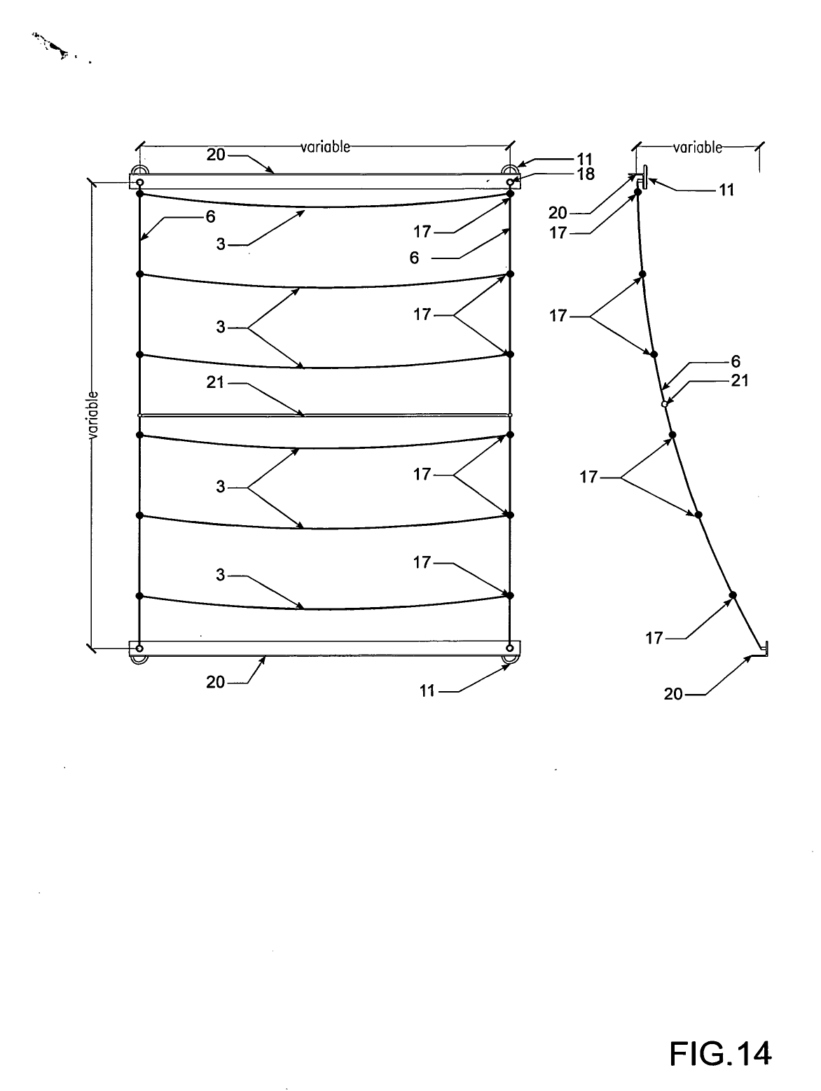

FIG. 14 illustrates an embodiment of the invention in which the support frame is composed of cables, held apart by transverse spreaders, in accordance with various embodiments of the present invention. The embodiment is characterized by the catenary form taken by two parallel vertically-oriented structural members 6. Transverse supports 3 are structurally coupled at each end 17 to each parallel vertically-oriented structural member 6. Each parallel vertically-oriented structural member 6 is fastened to a transverse spreader 20 at cable anchor 18. Transverse spreaders 20 hold each parallel vertically-oriented structural member 6 apart at a predetermined distance. Each transverse spreader is fitted with an anchor attachment 11 to permit coupling to a secondary structure such as a suspended tension cable or façade stand-off frame, where each may be ultimately supported by a primary structure according to convention. An auxiliary transverse spreader 21 may be employed at the mid-span of 6 to maintain proper distance between each member.

While the invention has been described with reference to specific embodiments, one skilled in the art will appreciate that various other adaptations and modifications may be made to the method and apparatus of the present invention, and that all such modifications and adaptations are intended to be encompassed within the scope of the invention.

What is claimed is:

1. A module for a vegetated wall system for growing plants comprised of:
A modular structural frame consisting of not less than two parallel vertically oriented structural members supporting not less than one transverse support,
A first continuous fabric folded horizontally over the modular structural frame such that the volume of the fold or folds may be sufficient to contain both plant material and growing medium on the ventral side with at least one opening to receive planting material, and selected from the group comprised of polymers/tangle material, synthetic fibers, adhered synthetic fibers, natural fibers, glass, ceramic, plastic, metal, or stone,
A second continuous fabric which is folded horizontally over the modular structural frame on the dorsal side and partially folded into the cavity or cavities produced by the fold or folds of the first fabric.

2. The module of claim 1, wherein the modular structural frame is composed of rigid structural elements capable of conducting both compressive and tensile forces.

3. The module of claim 1, wherein the parallel vertically oriented structural members are formed into a curve.

4. The module of claim 1, wherein the parallel vertically oriented structural members are composed of tensile structural elements, and wherein said elements are held at a desired distance apart by not less than two transverse spreaders.

5. The module of claim 1, wherein the transverse support is composed of tensile structural elements.

6. The module of claim 1, wherein the transverse support is composed of both compressive and tensile structural elements.

7. The module of claim 1, wherein the distal points of the parallel vertically oriented structural members are coupled to a fastener plate assembly.

8. The module of claim 1, wherein third or more discontinuous fabrics are overlaid within the fold or folds of the first continuous fabric.

9. The module of claim 1, wherein the openings at the ends of first continuous fabric are closed by means of a securing mechanism from the group consisting of adhesives, glue, synthetic fiber stitches, pins, tacks, wire, metal bindings, and solid framing.

10. A vegetated wall system for growing plants, the system including:
A first and a second module coupled to each other at the distal points of the vertically oriented structural members of the modular structural frame by way of a fastener plate assembly such that the second module is located below the first module, the first and the second module including:
An underlying modular structural frame consisting of not less than two parallel vertically oriented structural members supporting not less than one transverse support,
A first continuous fabric folded horizontally over the underlying modular structural frame such that the volume of the fold or folds may be sufficient to contain both plant material and growing medium on the ventral side with at least one opening to receive planting material, and selected from the group comprised of polymers/tangle material, synthetic fibers, adhered synthetic fibers, natural fibers, glass, ceramic, plastic, metal, or stone,
A second continuous fabric which is folded horizontally over the underlying modular structural frame on the dorsal side and partially folded into the cavity or cavities produced by the fold or folds of the first fabric,
An irrigation system composed of segments corresponding to each module and/or connected across the vegetated wall system.

11. The system of claim 10, further comprising third or more modules that are each configured as the first and second modules, and located below the first and second modules.

12. The system of claim 10, wherein vertically coupled modules are juxtaposed horizontally.

13. The system of claim 10, wherein the vertically coupled modules comprise a curved form, and including convex, concave, radiused or catenary curved forms.

14. The system of claim 10, wherein the first module may be raised or lowered by mechanical means and assisted by a guide assembly.

15. The system of claim 10, wherein the system is an exterior system.

16. The system of claim 10, wherein the system is an interior system.

17. The system of claim 10, wherein the modular structural frame is coupled to cables attached to a primary support by conventional means.

18. The system of claim 10, wherein the modular structural frame is coupled to a rigid frame attached to a primary support by conventional means.
